(19) United States
(12) Patent Application Publication
(10) Pub. No.: US 2018/0010381 A1
(43) Pub. Date: Jan. 11, 2018

(54) Thermally Insulated Door Assembly with an Operable Panel

(71) Applicant: Brian Daniel Crist, Lighthouse Point, FL (US)

(72) Inventor: Brian Daniel Crist, Lighthouse Point, FL (US)

(21) Appl. No.: 15/645,910

(22) Filed: Jul. 10, 2017

Related U.S. Application Data
(60) Provisional application No. 62/360,216, filed on Jul. 8, 2016.

(51) Int. Cl. E06B 3/58; E06B 3/263; E06B 3/28; E05C 9/02; E06B 3/663; E06B 3/70; E06B 7/16

(52) U.S. Cl. CPC E06B 3/5892; E06B 3/7015; E06B 3/26338; E06B 7/16; E05C 9/02; E06B 3/66309; E06B 3/28; E06B 2003/7046; E06B 2003/708

(57) ABSTRACT

A thermally insulated door assembly with an operable panel uses a pair of structural panels, a collection of thermally-insulating fasteners, a panel hole and an operable panel. The pair of structural panels are held together by the thermally-insulating fasteners. The thermally-insulating fasteners form a rigid structure that prevents thermal conductivity between the two structural panels that make up the door assembly. This arrangement enables the door assembly to remain a rigid structure while being composed of multiple components. The panel hole traverses through the pair of structural panels to form an opening into which the operable panel is inserted. The operable panel is a panel that replaces a central section of the door assembly. This placement enables the user to remove and replace the operable panel as desired.

The current application claims a priority to the U.S. Provisional Patent application Ser. No. 62/360,216 filed on Jul. 8, 2016. The current application is filed on Jul. 10, 2017 while Jul. 8, 2017 was on a weekend.

### FIELD OF THE INVENTION

The present invention relates generally to an entry door. More specifically, the present invention relates to an entry door with an operable glass panel that resists thermal transfer, water infiltration, and damage caused by strong winds

### BACKGROUND OF THE INVENTION

Art can be said to be the pursuit of beautiful forms. Painters and sculptors express beauty by creating objects that are pure expressions of beautiful ideas. While the beauty of these objects is often up for debate, it is often the case that these creations serve no practical function. A distinct difference between industrial designers and traditional artists is the industrial designer's pursuit of a proper marriage between form and function. This pursuit can be seen in the work of any skilled tradesman. However, it is often difficult to find a perfect balance between these two goals. One area where this imbalance can be seen is the craftsmanship of the common door. These devices are for the most part utilitarian in nature. However, some are so ornately manicured as to reduce their proper function.

The present invention, thermally insulated door assembly, is a marriage of a highly-reinforced door and a beautifully crafted frame. By using engineered sash locks, the present invention is able to incorporate operable windows into an entry door. In addition to the engineered sash locks, the present invention employs the use of flush bolts that anchor it in the closed position. The design of the present invention enables the door to function properly, even when subjected to hurricane-strength winds.

### BRIEF DESCRIPTION OF THE DRAWINGS

FIG. 1 is a front view of the present invention.

FIG. 2 is a rear view of the present invention.

FIG. 3 is a rear view of the first alternative embodiment of the present invention.

FIG. 4 is a cross sectional view of the present invention taken along line 4-4 in FIG. 1 where the doorframe is removed.

FIG. 5 is a cross sectional view of the first alternative embodiment of the present invention taken along line 4-4 in FIG. 1.

FIG. 6 is a cross sectional view of the present invention taken along line 4-4 in FIG. 1.

FIG. 7 is a front view of the present invention with the operable panel removed.

FIG. 8 is a front view of the present invention being used in a double door.

FIG. 9 is a cross sectional view of the present invention taken along line 9-9 in FIG. 8.

### DETAIL DESCRIPTIONS OF THE INVENTION

All illustrations of the drawings are for the purpose of describing selected versions of the present invention and are not intended to limit the scope of the present invention.

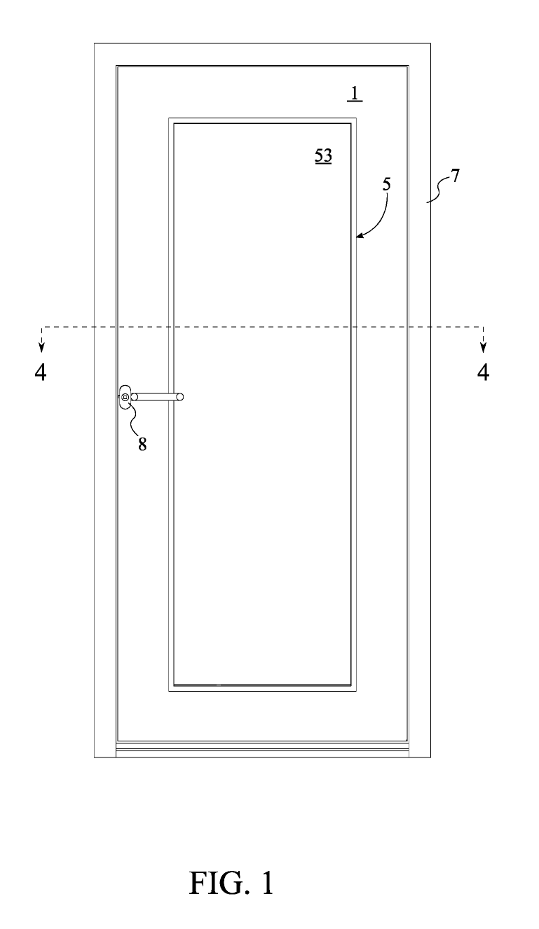

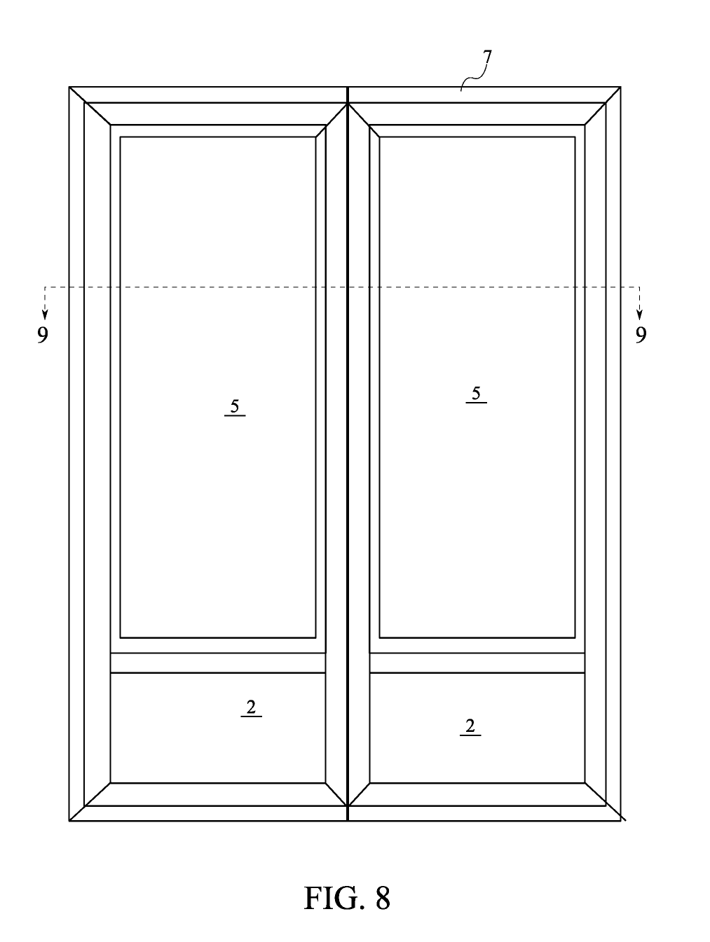

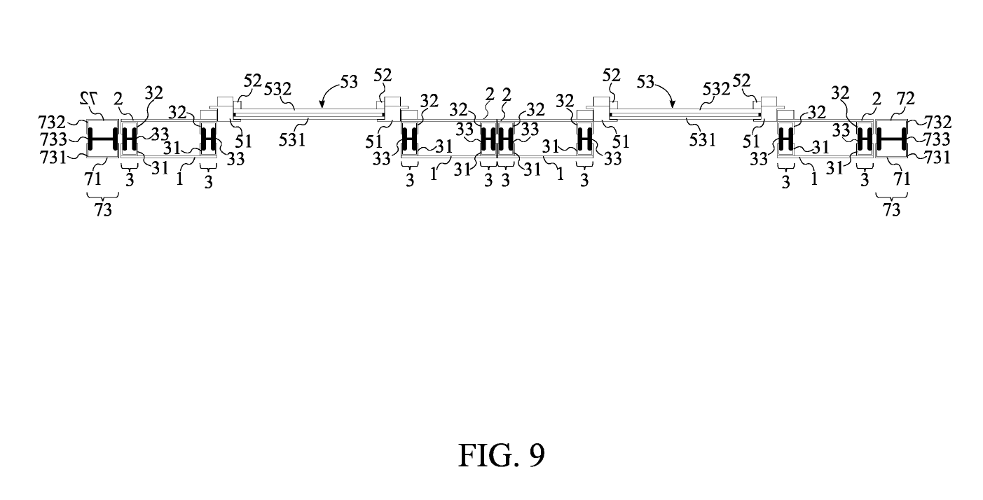

As can be seen in FIG. 1 through FIG. 9, the present invention, the thermally insulated door assembly, is a multicomponent door assembly that is designed to prevent thermal conductivity between the interior and exterior surfaces of the door. Additionally, the present invention is a door that is designed with an operable panel that enables a user to remove a central section of the door. By doing so, the user can repair or replace the central section of the door as desired. As such, the user is able to place a glass pane with ironwork detailing into the central section of the door for aesthetic purposes. Alternatively, the user is able to place a rigid panel into the central section of the door to cope with extreme weather or security conditions. Regardless of the type of materials used for the operable panel, the present invention makes use of a reinforced sash-locking system to maintain the operable panel's connection with the door around it. This sash-locking system is designed to enable the present invention to remain functional while being subjected to hurricane-force winds.

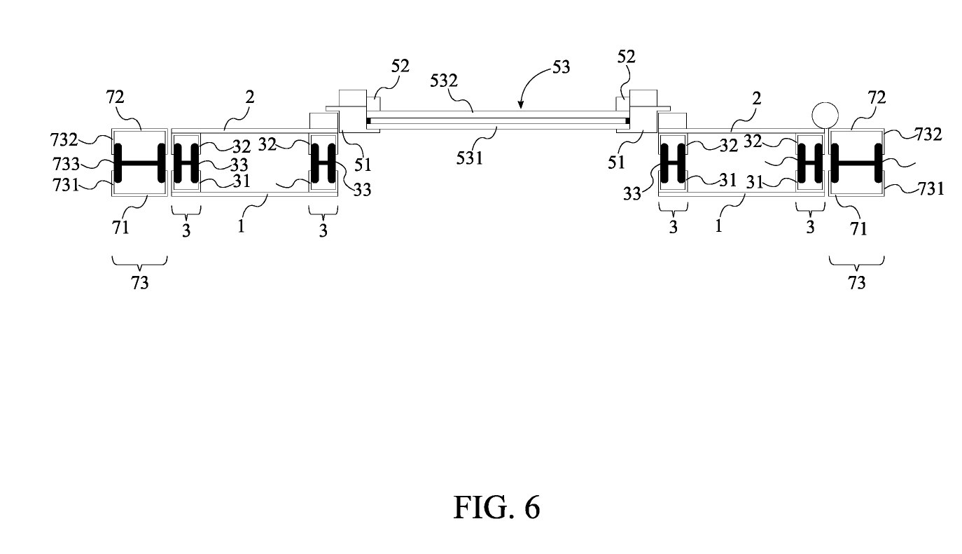

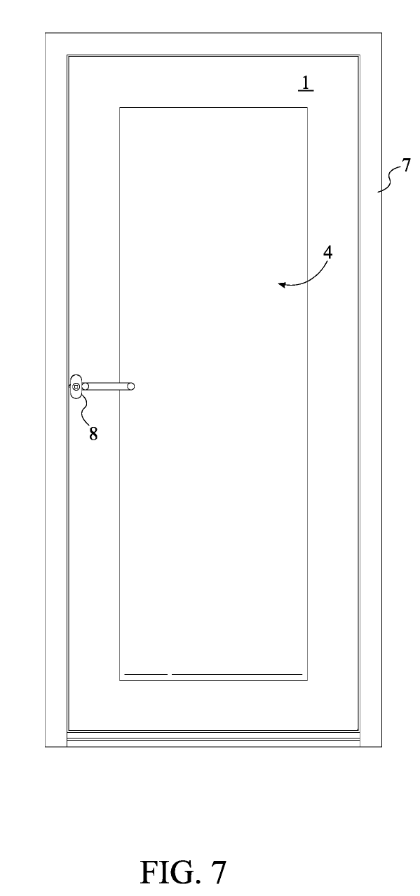

As can be seen in FIG. 1, FIG. 6, and FIG. 7, to achieve the above-described functionalities, the present invention comprises a first structural panel 1, a second structural panel 2, a plurality of thermally-insulating fasteners 3, a panel hole 4, and an operable panel 5. These components are arranged such that the exterior-facing side of the door is connected to the interior-facing side of the door by a thermal break. This thermal break prevents the exterior temperature of a building into which the present invention is integrated from affecting the interior temperature of the building. The first structural panel 1 is the exterior-facing side of the door and the second structural panel 2 is the interior-facing side of the door. Additionally, the plurality of thermally-insulating fasteners 3 is a collection of rigid connectors that are made of materials with low thermal conductivity ratings. As such, the first structural panel 1 and the second structural panel 2 are mounted parallel and offset from each other by the plurality of thermally-insulating fasteners 3. Consequently, the plurality of thermally-insulating fasteners 3 is the thermal break that connects the first structural panel 1 to the second structural panel 2. The panel hole 4 traverses normal and through the first structural panel 1 and the second structural panel 2. Accordingly, the panel hole 4 transforms the first structural panel 1 and the second structural panel 2 into frames that are designed to support the operable panel 5. Additionally, the plurality of thermally-insulating fasteners 3 is distributed around the panel hole 4. As a result, the plurality of thermally-isolating fasteners form a thermal break between the perimeter of the panel hole 4, the first structural panel 1, and the second structural panel 2. The operable panel 5 is positioned within the panel hole 4. Furthermore, the second structural panel 2 is peripherally attached to the operable panel 5. As a result, the operable panel 5 is mounted within the panel hole 4 by being attached to the second structural panel 2. This configuration enables the user to attach or detach the operable panel 5 from the interior-facing side of the door.

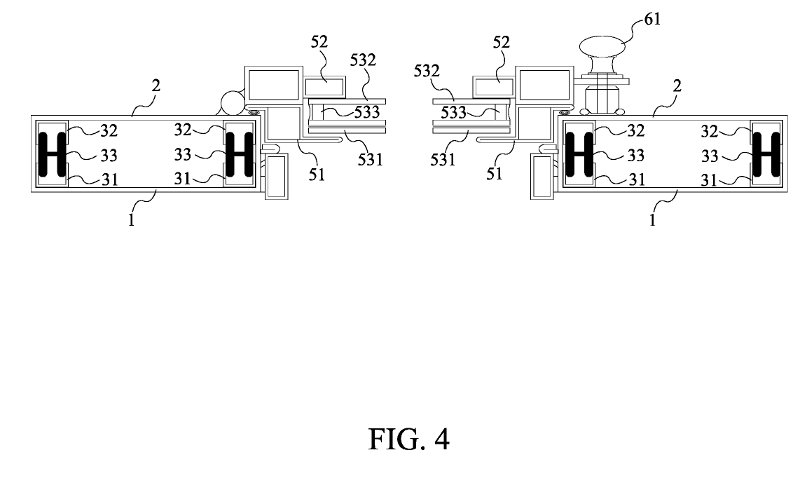

As can be seen in FIG. 1 and FIG. 4, the plurality of thermally-insulating fasteners 3 is used to form a rigid structure that extends between the first structural panel 1 and the second structural panel 2. This structure enables the door formed by the present invention to protect against forced entry and to remain undamaged while subjected to extreme weather conditions. Furthermore, the plurality of thermally-insulating fasteners 3 prevents thermal conductivity between the first structural panel 1 and the second structural panel 2. To accomplish this, each of the plurality of thermally-insulating fasteners 3 comprises a first bracket 31, a second bracket 32, and insulating structural member 33. The first bracket 31 and the second bracket 32 are rigid receptacles that form the connection points for the insulating structural member 33. The insulating structural member 33 is a rigid connector that has a poor thermal conductivity rating and can be manufactured from materials including, but not limited to, fiberglass, perlite, and polyurethane. The first bracket 31 is adjacently connected to the first structural panel 1. Likewise, the second bracket 32 is adjacently connected to the second structural panel 2. Finally, the insulating structural member 33 is connected in between the first bracket 31 and the second bracket 32. As a result, the insulating structural member 33 is able to offset the first structural panel 1 from the second structural panel 2. This creates a thermally insulating space between the first structural panel 1 and the second structural panel 2. In a first alternative embodiment, the present invention comprises an insulating filler 11 that increases the thermally insulating capabilities of the space between the first structural panel 1 and the second structural panel 2. To accomplish this, the insulating filler 11 is positioned in between the first structural panel 1 and the second structural panel 2. Thus positioned, the insulating filler 11 augments the thermal break created by the plurality of thermally-insulating fasteners 3. The insulating filler 11 is made of materials, including, but not limited to, mineral wool, insulating foam, and fiberglass.

As can be seen in FIG. 1 and FIG. 4, the operable panel 5 is preferably a window in the central section of the door that can be opened or removed. Specifically, the operable panel 5 comprises a sash 51, a transparent pane 53, and a glazing bead 52. The sash 51 is a rigid frame and the glazing bead 52 is a frame of molding that holds the transparent pane 53 in place within the sash 51. That is, the sash 51 is perimetrically mounted around the transparent pane 53 by the glazing bead 52. As a result, the sash 51, the glazing bead 52, and the transparent pane 53 form a window. Expounding on the descriptions of the sash 51, a transverse cross-section of the sash 51 comprises a first leg and a second leg. Additionally, the first leg is positioned normal to the second leg. Consequently, the transverse cross-section of the sash 51 is an L-shaped bracket with the first leg and the second leg being the corresponding legs of the L-shaped bracket. This configuration enables the sash 51 to be mounted around the transparent pane 53. As such, the first leg is adjacently connected to a first face of the transparent pane 53. Furthermore, the glazing bead 52 is adjacently connected to a second face of the transparent pane 53, opposite to the first leg. Accordingly, the first leg forms a brace, against which the transparent pane 53 is pressed by the glazing bead 52. Moreover, the transparent pane 53 is terminally connected to the second leg. Finally, the glazing bead 52 is adjacently connected to the second leg. Thus positioned, the sash 51 and the glazing bead 52 prevent the transparent pane 53 from moving independently of the sash 51. To increase longevity and usefulness of the operable panel 5, the present invention comprises a water seal 54. The water seal 54 is a piece of weather stripping made from materials including, but not limited to silicone, rubber, and polyurethane. Additionally, the water seal 54 is hermetically connected in between the sash 51 and the transparent pane 53 so that moister on the exterior-facing side of the door is unable to pass through the operable panel 5 into the interior-facing side of the door. The sash 51 is preferably designed to function as a thermal break that prevents the transfer of thermal energy between the interior-facing and the exterior-facing sides of the operable panel 5. To accomplish this a thermally-insulating material is integrated into the sash 51. In this way, the sash 51 is constructed as a multicomponent assembly that uses thermally-insulating material to act as both a connective structure and a thermal break. As such, the thermally-insulating material augments the thermal breaking properties of the operative panel 5 without compromising structural integrity. Additionally, thermally-insulating material may be placed in between the sash 51 and the transparent pane 53.

As can be seen in FIG. 1 and FIG. 4, the transparent pane 53 is a multicomponent windowpane that is designed for increased strength and thermal insulation. As such, the transparent pane 53 comprises a first glass pane 531, a second glass pane 532, and a pane spacer 533. The first glass pane 531 is positioned parallel to the second glass pane 532 so that the transparent pane 53 forms a sufficiently planar panel. The pane spacer 533 is a piece of thermally insulating material. Additionally, the pane spacer 533 is mounted in between the first glass pane 531 and the second glass pane 532. Thus positioned, the pane spacer 533 offsets the first glass pane 531 from the second glass pane 532 to create an insulating gap. The insulating gap and the pane spacer 533 work in conjunction to create a thermal break that prevents thermal conductivity between the first glass pane 531 and the second glass pane 532.

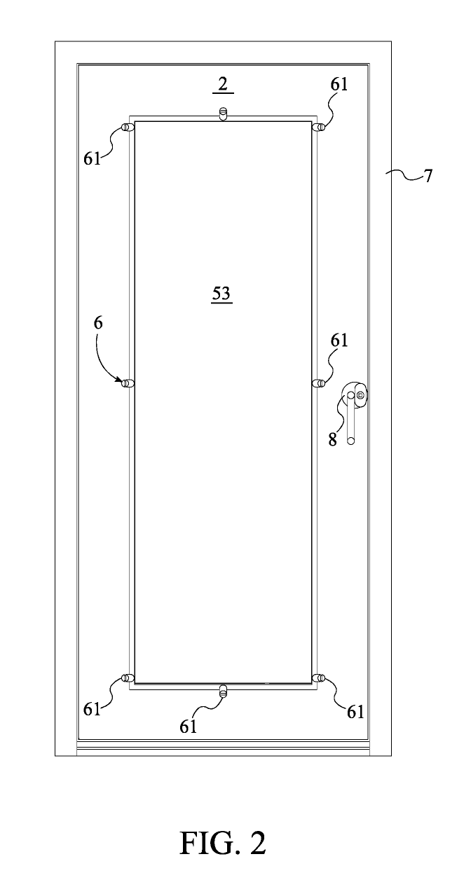

As can be seen in FIG. 1, FIG. 2, and FIG. 7, the present invention is designed to enable the user to open and close the panel hole 4 with the operable panel 5. To accomplish this, the present invention comprises a sash-locking mechanism 6. The sash-locking mechanism 6 is a device that can be engaged or disengaged to connect the operable panel 5 to the door created by the present invention. Specifically, the sash-locking mechanism 6 is mechanically integrated in between the operable panel 5 and the second structural panel 2, wherein the sash-locking mechanism 6 is used to attach the operable panel 5 to or to detach the operable panel 5 from the second structural panel 2. For example, when the operable panel 5 is hingedly connected to the second structural panel 2, the sash-locking mechanism 6 retains the operable panel 5 in a closed configuration while engaged. In the closed configuration, the operable panel 5 covers the panel hole 4. Conversely, when the sash-locking mechanism 6 is disengaged, the operable panel 5 is able to move into an opened configuration and rotate about the hinged connection with the second structural panel 2. Thus, uncovering the panel hole 4.

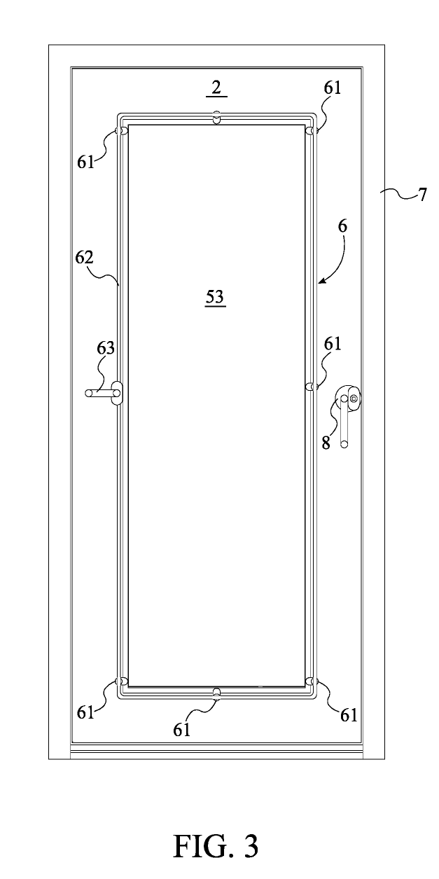

As can be seen in FIG. 1, FIG. 2, and FIG. 3, the sash-locking mechanism 6 can achieve the above-described functionality by using multiple configurations. In the preferred embodiment of the present invention, the sash-locking mechanism 6 comprises a plurality of cam locks 61. Each of the plurality of cam locks 61 is a user operable locking device that can be engaged or disengaged by being twisted. Furthermore, the plurality of cam locks 61 is peripherally distributed around the operable panel 5. Thus positioned, the plurality of cam locks 61 maintains the operable panel 5 in the closed configuration while engaged. Conversely, disengaging the plurality of cam locks 61 enables the operable panel 5 to move into the opened configuration. In the first alternative embodiment of the present invention, the sash-locking mechanism 6 makes use of an actuation assembly that enables the user to engage or disengage the plurality of cam locks 61, simultaneously. To accomplish this the sash-locking mechanism 6 comprises a slide-bar assembly 62 and an actuation lever 63. The slide-bar assembly 62 is a cremone system. A pair of bolts for the cremone system are used as linkage bars that actuate the plurality of cam locks 61. As such, the slide-bar assembly 62 is slidably mounted onto the sash 51 so that a pair of bolts are able to be retained in the appropriate position while actuating the plurality of cam locks 61. Additionally, the slide-bar assembly 62 is operatively coupled to the plurality of cam locks 61, wherein the slide-bar assembly 62 is able to lock and unlock the plurality of cam locks 61. Finally, the actuation lever 63 is torsionally connected to the slide-bar assembly 62. As a result, rotating the actuation lever 63 causes the slide-bar assembly 62 to engage or disengage the plurality of cam locks 61. The slide-bar assembly 62, the plurality of cam locks 61, and the actuation lever 63 work in concert to create a multipoint locking mechanism. As such, the plurality of cam locks 61 function as locks that are connected to the slide-bar assembly 62. The user is able to unlock the plurality of cam locks 61 by rotating the actuation lever 63. This creates a system that enables the user to unlock all of the plurality of cam locks 61 by simply rotating the actuation lever 63.

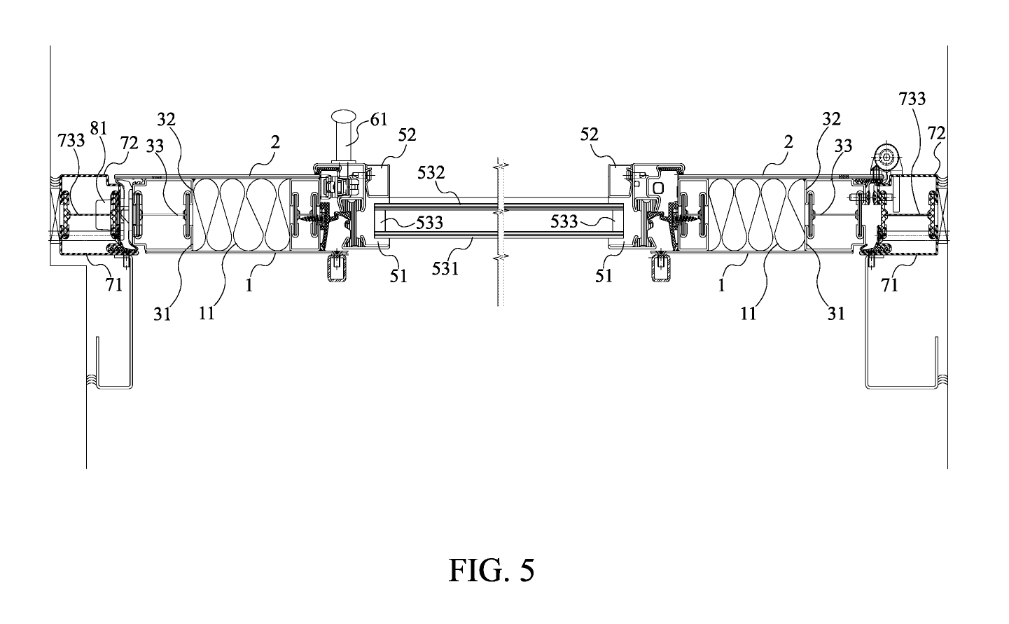

As can be seen in FIG. 1, FIG. 5, and FIG. 6, the present invention is designed to function as a complete doorway assembly that prevents thermal transfer between the interior and the exterior surfaces of a building. To accomplish this, the present invention comprises a doorframe 7 that is constructed using the same multicomponent architecture as the door. That is, the doorframe 7 comprises a first frame panel 71, a second frame panel 72, and a plurality of thermally-insulating frame fasteners 73. The first frame panel 71 is the exterior-facing side of the doorframe 7. Conversely, the second frame panel 72 is the interior-facing side of the doorframe 7. Finally, the plurality of thermally-insulating frame fasteners 73 forms the connective structure between the first frame panel 71 and the second frame panel 72. As such, the first frame panel 71 and the second frame panel 72 are mounted parallel and offset from each other by the plurality of thermally-insulating frame fasteners 73. Consequently, the plurality of thermally-insulating frame fasteners 73 functions as a thermal break between the first frame panel 71 and the second frame panel 72. Additionally, the second structural panel 2 is hingedly connected to the second frame panel 72. Accordingly, the door formed by the present invention is able to swing about the hinged connection between the second structural panel 2 and the second frame panel 72. The present invention can be adapted to work with double doors. For example, the doorframe 7 can be constructed wide enough to accommodate the width of two doors. In this example, the second structural panel 2 of each door is hingedly connected to opposite sides of the doorframe 7. Furthermore, an astragal may be connected to each door to increase strength and reduce thermal conductivity. The doorframe 7 may be constructed with a transom to add aesthetic appeal.

As can be seen in FIG. 1, FIG. 5, and FIG. 6, the plurality of thermally-insulating frame fasteners 73 is used to form the rigid structure that extends between the first frame panel 71 and the second frame panel 72. This structure enables the doorframe 7 to protect against forced entry and to remain undamaged while subjected to extreme weather conditions. Furthermore, the plurality of thermally-insulating frame fasteners 73 prevents thermal conductivity between the first frame panel 71 and the second frame panel 72. To accomplish this, each of the plurality of thermally-insulating frame fasteners 73 comprises a first frame bracket 731, a second frame bracket 732, and an insulting frame member. The first frame bracket 731 and the second frame bracket 732 are rigid receptacles that form the connection points for the insulating frame member 733. The insulating frame member 733 is a rigid connector that has a poor thermal conductivity rating and can be manufactured from materials including, but not limited to, fiberglass, perlite, and polyurethane. The first frame bracket 731 is adjacently connected to the first frame panel 71. Likewise, the second frame bracket 732 is adjacently connected to the second frame panel 72. Finally, the insulating frame member 733 is connected in between the first frame bracket 731 and the second frame bracket 732. As a result, the insulating frame member 733 is able to offset the first frame panel 71 from the second frame panel 72. This creates a thermally insulating space between the first frame panel 71 and the second frame panel 72.

As can be seen in FIG. 1, FIG. 5, and FIG. 6, the present invention is designed to incorporate the security features of a traditional door. As such the present invention comprises a lockset 8 and a lock receptacle 81. The lockset 8 is mounted in between the first structural panel 1 and the second structural panel 2. As a result, the first structural panel 1 and the second structural panel 2 maintain the lockset 8 in a position that is easily reached by the user. Additionally, the lock receptacle 81 is mounted in between the first frame panel 71 and the second frame panel 72, and the lockset 8 engages into the lock receptacle 81. Thus positioned, the lockset 8 and the lock receptacle 81 are able to work in concert to retain the door in a closed configuration within the doorframe 7. In addition to the lockset 8, the present invention comprises at least one flush bolt. The at least one flush bolt is peripherally mounted in between the first structural panel 1 and the second structural panel 2. as a result, the at least one flush bolt is able to add strength and stability to the present invention while the door is in the closed configuration.

Although the invention has been explained in relation to its preferred embodiment, it is to be understood that many other possible modifications and variations can be made without departing from the spirit and scope of the invention as hereinafter claimed.

What is claimed is:

1. A thermally insulated door assembly with an operable panel comprises:
a first structural panel;
a second structural panel;
a plurality of thermally-insulating fasteners;
a panel hole;
an operable panel;
the first structural panel and the second structural panel being mounted parallel and offset from each other by the plurality of thermally-insulating fasteners;
the panel hole traversing normal and through the first structural panel and the second structural panel;
the plurality of thermally-insulating fasteners being distributed around the panel hole;
the operable panel being positioned within the panel hole; and
the second structural panel being peripherally attached to the operable panel.

2. The thermally insulated door assembly with an operable panel as claimed in claim 1 comprises:
each of the plurality of thermally-insulating fasteners comprises a first bracket, a second bracket, and an insulting structural member;
the first bracket being adjacently connected to the first structural panel;
the second bracket being adjacently connected to the second structural panel; and
the insulating structural member being connected in between the first bracket and the second bracket.

3. The thermally insulated door assembly with an operable panel as claimed in claim 1 comprises:
the operable panel comprises a sash, a transparent pane, and a glazing bead; and
the sash being perimetrically mounted around the transparent pane by the glazing bead.

4. The thermally insulated door assembly with an operable panel as claimed in claim 3 comprises:
a transverse cross-section of the sash comprises a first leg and a second leg;
the first leg being positioned normal to the second leg;
the first leg being adjacently connected to a first face of the transparent pane;
the glazing bead being adjacently connected to a second face of the transparent pane, opposite to the first leg;
the transparent pane being terminally connected to the second leg; and
the glazing bead being adjacently connected to the second leg.

5. The thermally insulated door assembly with an operable panel as claimed in claim 3 comprises:
a water seal; and
the water seal being hermetically connected in between the sash and the transparent pane.

6. The thermally insulated door assembly with an operable panel as claimed in claim 3 comprises:
the transparent pane comprises a first glass pane, a second glass pane, and a pane spacer;
the first glass pane being positioned parallel to the second glass pane; and
the pane spacer being mounted in between the first glass pane and the second glass pane.

7. The thermally insulated door assembly with an operable panel as claimed in claim 1 comprises:
a sash-locking mechanism; and
the sash-locking mechanism being mechanically integrated in between the operable panel and the second structural panel, wherein the sash-locking mechanism is used to attach the operable panel to or to detach the operable panel from the second structural panel.

8. The thermally insulated door assembly with an operable panel as claimed in claim 7, wherein the operable panel is hingedly connected to the second structural panel.

9. The thermally insulated door assembly with an operable panel as claimed in claim 7 comprises:
the sash-locking mechanism comprises a plurality of cam locks; and
the plurality of cam locks being peripherally distributed around the operable panel.

10. The thermally insulated door assembly with an operable panel as claimed in claim 7 comprises:
the sash-locking mechanism comprises a plurality of cam locks, a slide-bar assembly, and an actuation lever;
the plurality of cam locks being peripherally distributed around the operable panel;
the slide-bar assembly being slidably mounted onto the sash;
the slide-bar assembly being operatively coupled to the plurality of cam locks, wherein the slide-bar assembly is able to lock and unlock the plurality of cam locks; and
the actuation lever being torsionally connected to the slide-bar assembly.

11. The thermally insulated door assembly with an operable panel as claimed in claim 1 comprises:
a doorframe;
the doorframe comprises a first frame panel, a second frame panel, a plurality of thermally-insulating frame fasteners;
the first frame panel and the second frame panel being mounted parallel and offset from each other by the plurality of thermally-insulating frame fasteners; and
the second structural panel being hingedly connected to the second frame panel.

12. The thermally insulated door assembly with an operable panel as claimed in claim 11 comprises:
each of the plurality of thermally-insulating frame fasteners comprises a first frame bracket, a second frame bracket, and an insulting frame member;
the first frame bracket being connected to the first frame panel;
the second frame bracket being connected to the second frame panel; and
the insulating frame member being connected in between the first frame bracket and the second frame bracket.

13. The thermally insulated door assembly with an operable panel as claimed in claim 11 comprises:
a lockset;
a lock receptacle;
the lockset being mounted in between the first structural panel and the second structural panel;
the lock receptacle being mounted in between the first frame panel and the second frame panel; and
the lockset engaging into the lock receptacle.

14. The thermally insulated door assembly with an operable panel as claimed in claim 1 comprises:
an insulating filler; and
the insulating filler being positioned in between the first structural panel and the second structural panel.

15. A thermally insulated door assembly with an operable panel comprises:
a first structural panel;
a second structural panel;
a plurality of thermally-insulating fasteners;
a panel hole;
an operable panel;
a water seal;
a sash-locking mechanism;
a doorframe;
a lockset;
a lock receptacle;
an insulating filler;
each of the plurality of thermally-insulating fasteners comprises a first bracket, a second bracket, and an insulting structural member;
the operable panel comprises a sash, a transparent pane, and a glazing bead;
the doorframe comprises a first frame panel, a second frame panel, a plurality of thermally-insulating frame fasteners;
each of the plurality of thermally-insulating frame fasteners comprises a first frame bracket, a second frame bracket, and an insulting frame member;
the first structural panel and the second structural panel being mounted parallel and offset from each other by the plurality of thermally-insulating fasteners;
the panel hole traversing normal and through the first structural panel and the second structural panel;
the plurality of thermally-insulating fasteners being distributed around the panel hole;
the operable panel being positioned within the panel hole;
the second structural panel being peripherally attached to the operable panel;
the first bracket being adjacently connected to the first structural panel;
the second bracket being adjacently connected to the second structural panel;
the insulating structural member being connected in between the first bracket and the second bracket;
the sash being perimetrically mounted around the transparent pane by the glazing bead;
the water seal being hermetically connected in between the sash and the transparent pane;
the sash-locking mechanism being mechanically integrated in between the operable panel and the second structural panel, wherein the sash-locking mechanism is used to attach the operable panel to or to detach the operable panel from the second structural panel;
the first frame panel and the second frame panel being mounted parallel and offset from each other by the plurality of thermally-insulating frame fasteners;
the second structural panel being hingedly connected to the second frame panel;
the first frame bracket being connected to the first frame panel;
the second frame bracket being connected to the second frame panel;
the insulating frame member being connected in between the first frame bracket and the second frame bracket;
the lockset being mounted in between the first structural panel and the second structural panel;
the lock receptacle being mounted in between the first frame panel and the second frame panel;
the lockset engaging into the lock receptacle; and
the insulating filler being positioned in between the first structural panel and the second structural panel.

16. The thermally insulated door assembly with an operable panel as claimed in claim 15 comprises:
a transverse cross-section of the sash comprises a first leg and a second leg;
the first leg being positioned normal to the second leg;
the first leg being adjacently connected to a first face of the transparent pane;
the glazing bead being adjacently connected to a second face of the transparent pane, opposite to the first leg;
the transparent pane being terminally connected to the second leg; and
the glazing bead being adjacently connected to the second leg.

17. The thermally insulated door assembly with an operable panel as claimed in claim 15 comprises:
the transparent pane comprises a first glass pane, a second glass pane, and a pane spacer;
the first glass pane being positioned parallel to the second glass pane; and
the pane spacer being mounted in between the first glass pane and the second glass pane.

18. The thermally insulated door assembly with an operable panel as claimed in claim 15, wherein the operable panel is hingedly connected to the second structural panel.

19. The thermally insulated door assembly with an operable panel as claimed in claim 15 comprises:
the sash-locking mechanism comprises a plurality of cam locks; and
the plurality of cam locks being peripherally distributed around the operable panel.

20. The thermally insulated door assembly with an operable panel as claimed in claim 15 comprises:
the sash-locking mechanism comprises a plurality of cam locks, a slide-bar assembly, and an actuation lever;
the plurality of cam locks being peripherally distributed around the operable panel;
the slide-bar assembly being slidably mounted onto the sash;
the slide-bar assembly being operatively coupled to the plurality of cam locks, wherein the slide-bar assembly is able to lock and unlock the plurality of cam locks; and
the actuation lever being torsionally connected to the slide-bar assembly.
